(19) United States
(12) Patent Application Publication
(10) Pub. No.: US 2014/0052618 A1
(43) Pub. Date: Feb. 20, 2014

(54) ELECTRONIC RECEIPT SAVER SYSTEM

(71) Applicants: Vadim Drozd, Apple Valley, MN (US); Robert N. Ross, Gardner, MA (US)

(72) Inventors: Vadim Drozd, Apple Valley, MN (US); Robert N. Ross, Gardner, MA (US)

(21) Appl. No.: 13/967,341

(22) Filed: Aug. 15, 2013

Related U.S. Application Data
(60) Provisional application No. 61/683,850, filed on Aug. 16, 2012.

(51) Int. Cl. G06Q 20/04

(52) U.S. Cl. CPC G06Q 20/0453
USPC 705/39

(57) ABSTRACT

Disclosed is an electronic receipt saver system for monetary transactions and return transactions comprising: a unique consumer access coded device having a kit including an individual card, a key fob, and software for personal computing devices. The consumer access coded device can be hosted on selected debit cards and credit cards. The electronic receipt saver system enables a consumer to archive monetary transactions into a single secured database accessible to the consumer via the computing devices to view and organize electronic receipts for financial records.

### CROSS-REFERENCE TO RELATED APPLICATION

The present Application is related to Provisional Patent Application entitled “Receipt Saver Pro,” filed 16 Aug. 2012 and assigned filing No. 61/683,859, incorporated herein by reference in its entirety.

### BACKGROUND OF THE INVENTION

Consumers obtain sales receipts from almost every purchase. It is important to retain sales receipts for sales or warranty returns. Most receipts are currently given in the form of a printed paper receipt. However, it can be very difficult for people to keep track of their paper receipts. With each new purchase or expenditure, people may simply shove the paper receipt into their wallet or purse, only to pile up and make a mess. Without a receipt, however, people may not be able to return purchased items or get their money back at many stores. Additionally, locating and organizing receipts can be a hassle when filing tax returns or when reconciling a bank account statement against their actual transactions.

There are existing systems used by financial institutions, such as banks and credit card companies, that track only expenses associated with purchases made by a consumer using a particular account associated with the financial institution. These systems are limited to archiving historical transactions that are purchased using only the method of payments associated with financial institutions check and debit card or credit card issued to their particular account. Consumers, however, make purchases using many different monetary methods including; cash, checks, debit cards and credit cards issued from more than one financial institution. Consumers also make monetary transactions via online purchases and ATM transactions. A system that can selectively archive receipts for all types of consumer transactions and payment methods is needed.

There are new systems where the person who receives a paper receipt can independently scan the paper receipt with a computer connected scanner or with a personal computing device, such as a smart phone, and the person can then save or send the scanned file to a database. These systems still require the person to collect and handle paper receipts from all their transactions. An effective paperless solution is necessary.

Moreover, as online purchases are increasingly being made by consumers; electronic receipts may be provided by e-mail to the consumer's email address. But these electronic receipts are not retained in a central location for storing electronic receipts, but are usually stored along with all other types of receipts. Consequently, there is typically not a logical database within a consumer's e-mail account to adequately manipulate the purchase receipts.

U.S. Pat. No. 7,797,192 issued to Mitchell et al., for example, teaches specific programming for a system to generate an electronic receipt and to receive an electronic receipt. The system discloses specific content for the receipt in particular for use by a merchant for receiving images of multiple types of currency and merchant financial tracking. This method is too complex and may be specific to only one type of merchant's electronic receipt generation system. Other, different, merchant electronic receipt generation systems may become available to the consumer. Therefore, a system needs to be developed for the consumer to be able to collect electronic receipts from multiple points of sale that use different types of electronic receipt generating systems including; retail purchases, internet purchases, ATM transactions and the like. An effective universal system providing consumer access coded to achieve a paperless electronic receipt solution is needed for the consumer.

### BRIEF SUMMARY OF THE INVENTION

In one aspect of the present invention, an electronic receipt saver system comprises: a consumer access coded device for generating an electronic receipt for a monetary transaction made by a consumer, and a receipt saver secure database for archiving the electronic receipt; wherein the consumer access coded device is uniquely associated with the consumer and the electronic receipt, the electronic receipt being transmitted electronically during the monetary transactions to the receipt saver secure database, the receipt saver secure database being accessible to the consumer via a computing device to view and organize the electronic receipt.

In another aspect of the present invention, an electronic receipt saver system comprises: a consumer access coded device for archiving an electronic receipt from at least one of a cash transaction, a check transaction, a debit card transaction, a credit card transaction, and a return transaction made by a consumer, wherein the consumer access coded device is uniquely associated with the consumer and the electronic receipt, and wherein the electronic receipts are transmitted electronically during the cash transactions, check transactions, debit cards transactions, credit card transactions, and return transactions, to a receipt saver secure database accessible to the consumer via a computing device to view and organize the electronic receipts.

In yet another aspect of the present invention, an electronic receipt saver system comprises: a consumer access coded kit including a card with magnetic strip, an electronic key fob, and downloadable software on a personal computing device for archiving an electronic receipt for a monetary transaction made by a consumer, wherein a consumer access coded kit is uniquely associated with the consumer and the electronic receipts, and the electronic receipts are transmitted electronically during the monetary transaction to a receipt saver secure database accessible to the consumer via a computing device to view and organize the electronic receipt for future returns and financial records.

The additional features and advantage of the disclosed invention is set forth in the detailed description which follows, and will be apparent to those skilled in the art from the description or recognized by practicing the invention as described, together with the claims and appended drawings.

### BRIEF DESCRIPTION OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a functional block diagram of an electronic receipt saver system, in accordance with the present invention;

FIG. 2 is a perspective view of one embodiment of a consumer access coded device in the form of a card with a magnetic strip, suitable for use in the electronic receipt saver system of FIG. 1;

FIG. 3 is a perspective view of one embodiment of a consumer access coded device in the form of a key fob, suitable for use in the electronic receipt saver system of FIG. 1;

FIG. 4 is a perspective view of a retail transaction scanning the consumer access coded card of FIG. 1;

FIG. 5 is a perspective view of a retail transaction scanning bar codes on the consumer access coded devices of FIGS. 2 and 3;

FIG. 6 is a perspective view of devices suitable for making an online transaction, in accordance with the present state of the art;

FIG. 7 is a perspective view of an embodiment of a customer access coded kit, suitable for use in the electronic receipt saver system of FIG. 1; and

FIG. 8 is a block diagram describing multiple types of transactions using the electronic receipt saver system of FIG. 1.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The disclosed invention includes an electronic receipt saver system that uses a consumer access coded device (CACD) to: (i) associate electronic receipts with each monetary transaction and monetary return transaction, (ii) archive electronic receipts to an online personal database for secure storage and for future access by the consumer for sales and warranty return history, and (iii) collect and track the consumer's financial spending data.

The electronic receipt saver system provides consumers with an easy and paperless way to save and organize receipts in one consolidated online database. This innovative system comprises a dedicated consumer access coded device provided in multiple formats to associate monetary transaction and to an online secure database. When the consumer makes a purchase, a retail cashier can swipe or scan the consumer's card associating a consumer access code to the present transaction, an action which can send an electronic receipt into the personal online database of the consumer.

Consumers may also send their receipts to their respective databases when shopping online by using dedicated CACD software, or by using an ATM via the CACD comprising a host debit card having the consumer access code added to the card. By using the electronic receipt saver system, a consumer need not worry about saving and storing paper receipts, which can be a hassle.

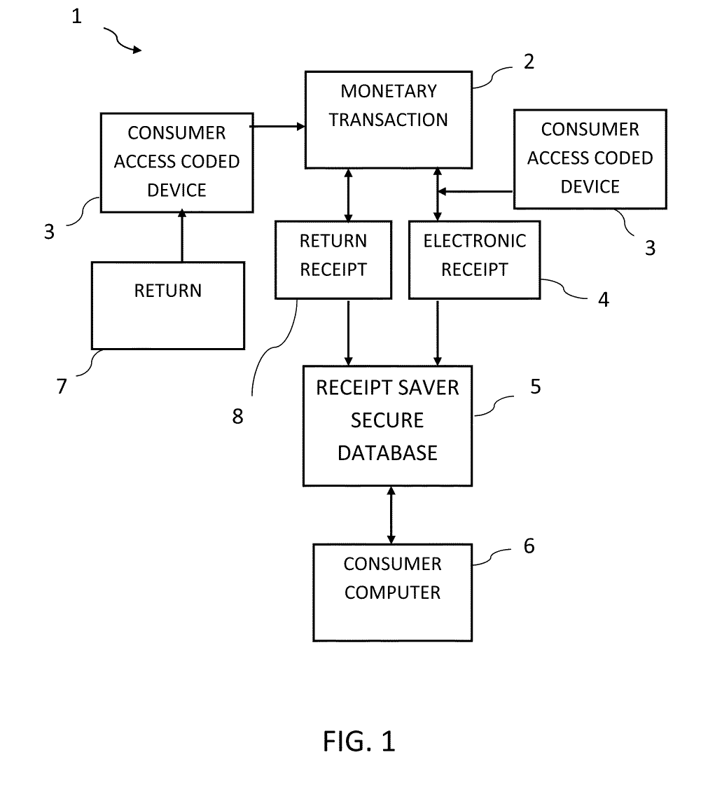

The electronic receipt saver system enables a consumer to associate the dedicated code to each transaction and subsequent return transaction. The electronic receipt saver system also enables the consumer to save, organize, and archive receipts online in one location, rather than having to save stacks of paper receipts. FIG. 1 is a functional block diagram of an electronic receipt saver system 1, in accordance with the present invention. To access the electronic receipt saver system 1, a consumer may acquire a consumer access coded device 3. Preferably, the coded access device 3 would be available in different forms or as a kit.

When the consumer makes a monetary transaction 2, the coded access device 3 may be presented to a retail clerk, for example. The coded access device 3 associates a unique code (assigned to the customer) to the transaction, and an electronic receipt 4 is thereby generated. The electronic receipt 4 may be sent to a secure database 5, which may be a secured server or a cloud server. The consumer may then use a personal computing device 6 to access such electronic receipts 4 when archived on the secure database 5.

If a return 7 is desired, the consumer may present the consumer access coded device 3 to verify association with the electronic receipt 4 of the monetary transaction 2. The monetary transaction 2 may comprise any acceptable medium of financial exchange including, for example, cash, check, debit card, and credit card. A record, such as a software file, related to the electronic receipt 4 is associated with the unique consumer code on the consumer access coded device 3.

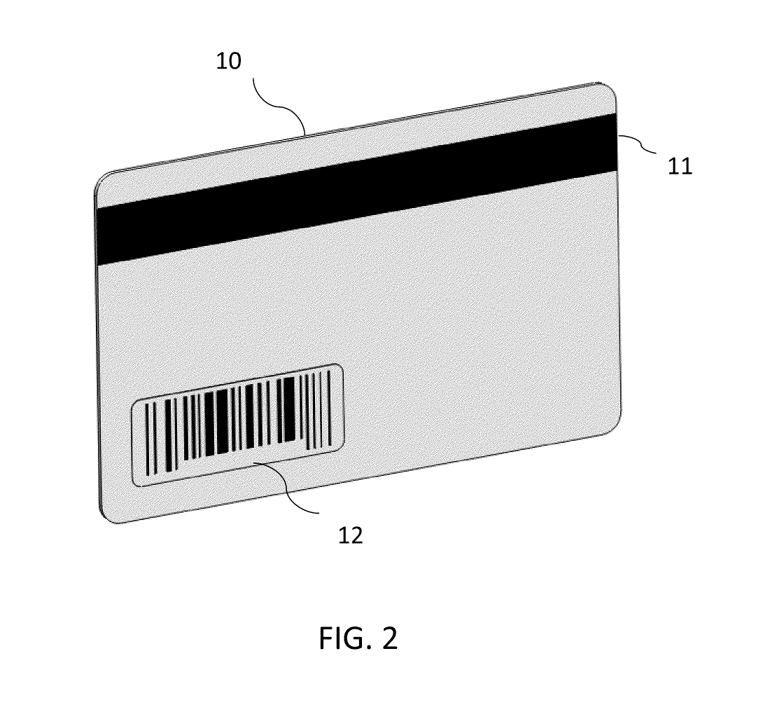

Referring to FIG. 2, one preferred embodiment for the consumer access coded device is in the form of a card 10, as is known in the art. The card 10 may comprise a dedicated card having the consumer access code encoded on a magnetic strip 11. In addition to the magnetic strip 11, a barcode 12 can be added to the card 10 to also allow the consumer code to be read by a barcode scanner. The barcode 12 may be printed directly onto the card 10 or it can alternatively be a printed label that is adhered to the card 10.

The consumer access code may be swiped and recorded in the same manner as a conventional debit card or credit card. The card 10 may also comprise an actual debit card or a credit card, and may serve as a “host” for the consumer access code. The consumer access code may be added to the magnetic strip of the debit or credit card under agreement with a card provider.

When a consumer utilizing the host debit or credit card makes a purchase, or withdraws money from an ATM, the access code contained on the magnetic strip 11 is associated with the transaction. This transaction functions to send the electronic receipt 4 to the consumer's online secured database 5, as shown in FIG. 1. Likewise, when a monetary transaction of any type is made, scanning the barcode label 12 associates the consumer access code to the transaction, and sends a copy of the transacted electronic receipt 4 into the appropriate online receipt saver secure database 5.

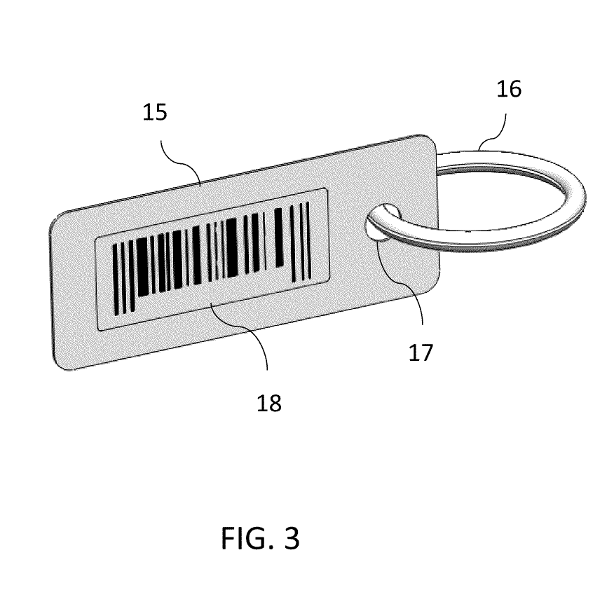

Referring to FIG. 3, a smaller version of the consumer access coded device that can attach to a person's keychain may also be offered for use in the electronic receipt saver system 1. An electronic key fob 15 is configured so as to be attachable to a key ring 16 via a hole 17. The electronic key fob 15 is an alternative design that will send an electronic generated coded signal to a detector (not shown). In this embodiment, the barcode 18 may be scanned to link the transaction to the receipt saver secure database 5 in a similar manner as that with the card 10, as described above.

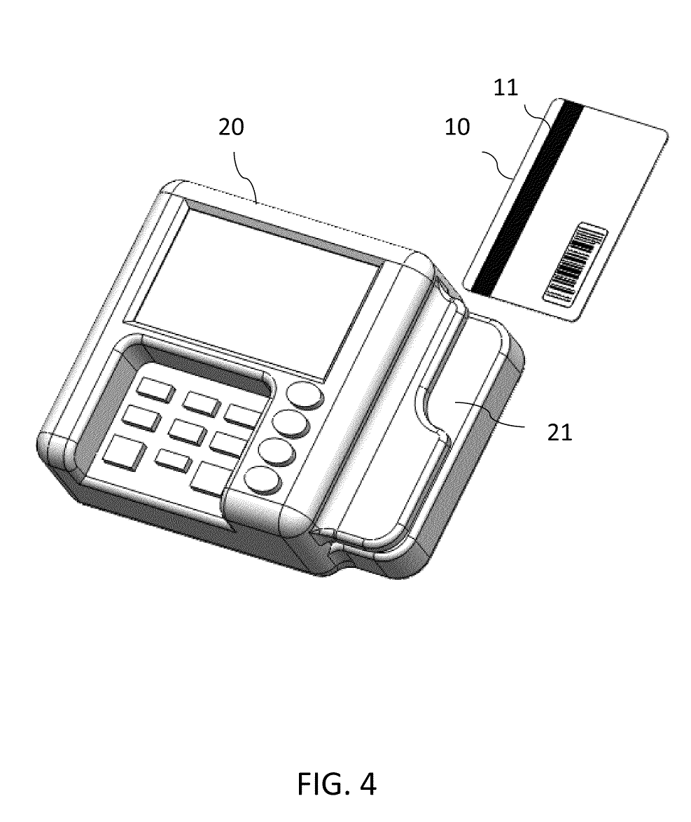

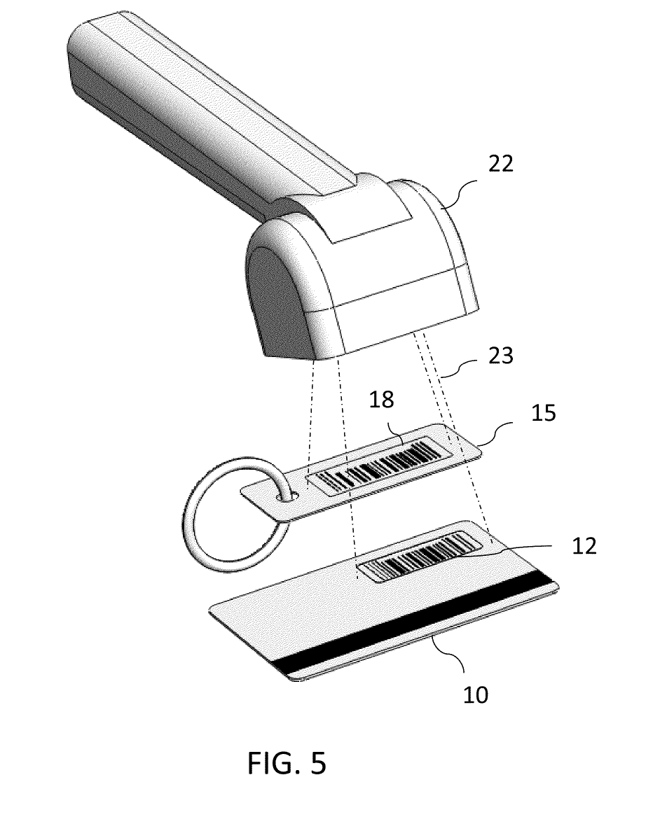

FIG. 4 illustrates a typical consumer access coded card transaction where a card reader 20 can read the magnetic strip 11 of the consumer coded card 10 via magnetic strip reader 21 to link the customer code access to the sales transaction and electronic receipt 4. When the card 10 is a host debit or credit card, the funding and customer code information may be presented simultaneously. FIG. 5 illustrates how a bar code scanning transaction can be recorded using a handheld barcode scanner 22 to scan the bar code 18 on the key fob 15 or the barcode 12 on the card 10. This method of barcode scanning is particularly useful with cash or check transactions.

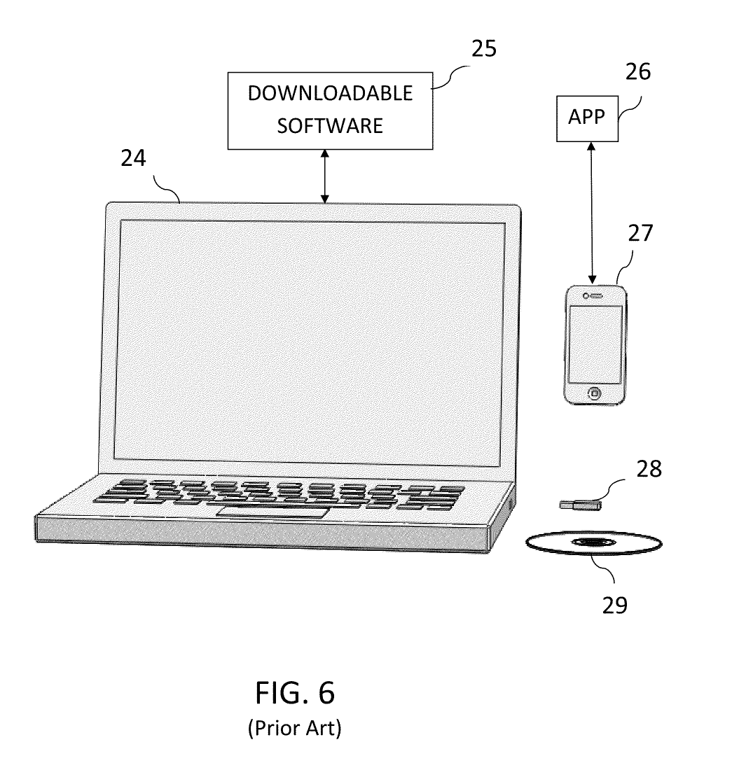

Referring to FIG. 6, the consumer can also use a personal computing device as the consumer access coded device to make monetary transactions. Personal computing devices may include, for example, a wired or wireless computer 24 with access to online downloadable receipt saver software 25, or a flash drive 28 with software and instructions, or a traditional compact disc 29 to load software and containing instructions. Other personal computing devices may include a personal smart phone 27 or a computer tablet (not shown) having access to a dedicated system app 26 to download software and instructions.

By using the personal computing device and software, the consumer can communicate with a coded access device and present a unique code when shopping online to automatically send and archive electronic receipts 4 into the related database as well. Using the personal computing device, the consumer may then access the dedicated and secured database 5 to view and organize the electronic receipts 4 via unique personal username and password.

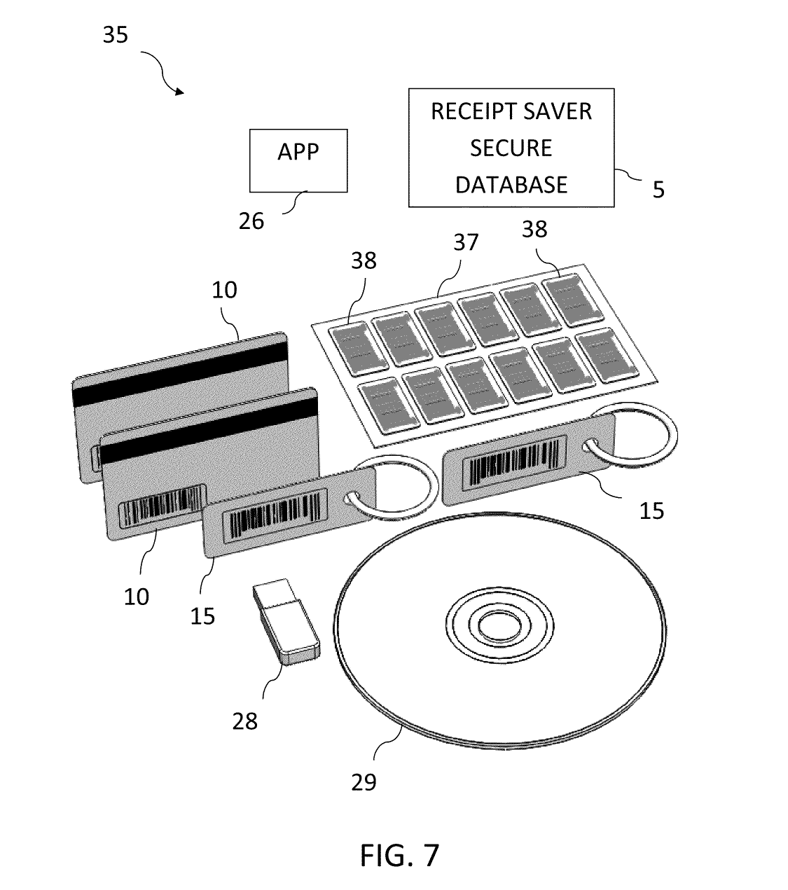

To ensure that the consumer can obtain electronic receipts for all types of monetary transactions, a consumer coded access kit 35, shown in FIG. 7, can be provided for use by the consumer. The consumer coded access kit 35 may comprise one or more dedicated cards 10 having a magnetic strip and bar codes, one or more key fobs 15, a sheet 37 containing adhesive barcode labels 38 to adhere to the consumer debit cards and credit cards for access. The consumer coded access kit 25 may also comprise Receipt Saver software on a compact disc 29 and/or on a flash drive 28. The Receipt Saver software may contain instructions to: (i) set up a secure account, (ii) access the online database 5, (iii) access an app 26, and (iv) run software to organize and manipulate data collected for all receipts.

An ATM transaction 48 was made using a debit card 49 that may be hosting a consumer code. A personal smart phone 50 may have been used by the consumer to check receipt status in the database 41. Computer 52 may have been used to make an online transaction 53. Preferably, the computer 52 included a Receipt Saver Pro software app (not shown) to provide the consumer access code.

In the case where an item purchased from the first retailer 44 needed to be returned, the retailer 44 may accept only a printed receipt. Accordingly, the consumer provides a printed receipt 60, and presents the printed receipt 60 to the retailer 44 along with the item being returned. Subsequently, the consumer may submit a report 61 with a summary of all electronic receipts 4 for use by an accountant 62. There are many other scenarios that can be implemented with the electronic receipt saver system 1.

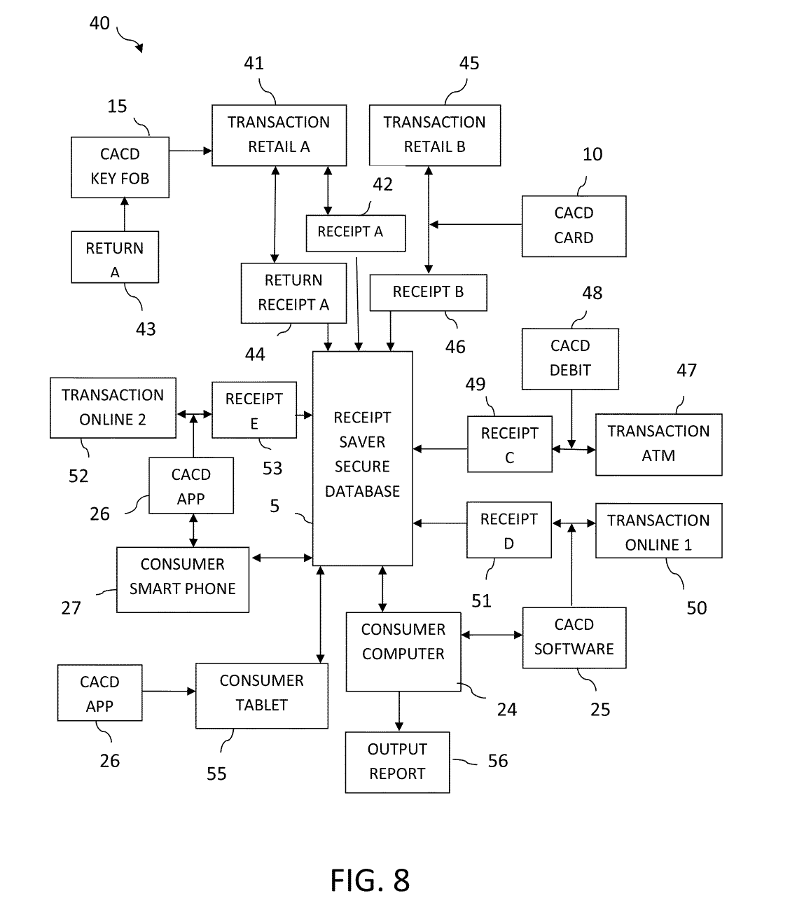

Referring now to FIG. 8 will more clearly illustrate the various types of electronic receipt transactions a consumer can make using the electronic receipt saver system 1. The block diagram 40 shows the central receipt saver secure database 5. A transaction at a first retailer 41 is generated, and a consumer access coded device in the form of a key FOB 15 may be used to generate a receipt A 42 that is sent to the receipt saver secure database 5.

If a return 43 is desired the consumer may present the consumer access coded key fob 15 to the first retailer 41. Alternatively, another consumer access coded device supplied within the kit 35, shown in FIG. 7, can be used for presentment. The first retailer may generate a return receipt 44 that is sent to the receipt saver secure database 5. There may be another transaction, at a second retailer 45. A consumer access coded device in the form of a dedicated card 10 may be used to generate a second receipt 46 that is sent to the receipt saver secure database 5.

The consumer may make an ATM transaction 47 using a consumer access coded device in the form of a host debit CACD card 48 to create a third receipt 49, that also is sent to the receipt saver secure database 5. An online transaction 50 can be made using the consumer computer 24 via downloaded consumer access coded access software 25 to generate a fourth receipt 51, that is also sent to the receipt saver secure database 5.

Another online transaction 52 can be made using a consumer smart phone 27 via a downloaded app 26 to generate a fifth receipt 53 that is also sent to the receipt saver secured database 5. A consumer tablet 55 can access the receipt saver secured database 5 to view and manipulate transactions via the downloaded app 26. Finally, the consumer computer 24 can be used along with the downloaded software 25 to organize the stored receipts within secured the receipt saver secure database 5 to generate an output report 56 for financial analysis and reporting purposes, for example.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated. The accompanying drawings are included to provide a further understanding of various features and embodiments of the method and devices of the invention which, together with their description serve to explain the principles and operation of the invention.

What is claimed to be new and novel and we pray to be secured by Letters Patent in the United States is described within the Claims section.

1. An electronic receipt saver system comprising:
a consumer access coded device for generating an electronic receipt for a monetary transaction made by a consumer, and
a receipt saver secure database for archiving said electronic receipt;
wherein said consumer access coded device is uniquely associated with the consumer and said electronic receipt, said electronic receipt being transmitted electronically during said monetary transactions to said receipt saver secure database, said receipt saver secure database being accessible to the consumer via a computing device to view and organize said electronic receipt.

2. The electronic receipt saver system of claim 1 wherein said computing device comprises at least one of: a wired personal computer, a wireless personal computers, and a personal mobile computing device.

3. The electronic receipt saver system of claim 1 wherein said consumer access coded device comprises a card having a magnetic strip.

4. The electronic receipt saver system of claim 1 wherein said consumer access coded device comprises an electronic key fob.

5. The electronic receipt saver system of claim 1 wherein said consumer access coded device comprises said computing device having downloaded software.

6. The electronic receipt saver system of claim 5 wherein said computing device comprises at least one of: a wired personal computer, a wireless personal computers, and a personal mobile computing device.

7. The electronic receipt saver system of claim 1 wherein said monetary transaction comprises at least one of; a cash transaction, a check transaction, an ATM transaction, an online transaction, a debit card transaction, a credit card transaction, and a return transaction.

8. The electronic receipt saver system of claim 1 wherein said consumer access coded device comprises a host debit card or a host credit card utilized by the consumer.

9. An electronic receipt saver system comprising:
a consumer access coded device for archiving an electronic receipt from at least one of a cash transaction, a check transaction, a debit card transaction, a credit card transaction, and a return transaction made by a consumer,
wherein said consumer access coded device is uniquely associated with the consumer and said electronic receipt,
and wherein said electronic receipts are transmitted electronically during said cash transactions, check transactions, debit cards transactions, credit card transactions, and return transactions, to a receipt saver secure database accessible to the consumer via a computing device to view and organize said electronic receipts.

10. The electronic receipt saver system of claim 9 wherein said computing device comprises one of a wired personal computer, a wireless personal computer, and a personal mobile computing device.

11. The electronic receipt saver system of claim 9 wherein said consumer access coded device is comprises a card having a magnetic strip.

12. The electronic receipt saver system of claim 9 wherein said consumer access coded device comprises an electronic key fob.

13. The electronic receipt saver system of claim 9 wherein said consumer access coded device comprises said computing device having down loaded software.

14. The electronic receipt saver system of claim 9 wherein said consumer access coded device comprises a host debit card or a host credit card utilized by the consumer.

15. The electronic receipt saver system of claim 12 wherein said computing device comprises one of a wired personal computer, a wireless personal computer, and a personal mobile computing device.

16. An electronic receipt saver system comprising:
a consumer access coded kit including a card with magnetic strip, an electronic key fob, and downloadable software on a personal computing device for archiving an electronic receipt for a monetary transaction made by a consumer,
wherein a consumer access coded kit is uniquely associated with the consumer and said electronic receipts, and said consumer's electronic receipts are transmitted electronically during said monetary transaction to a receipt saver secure database accessible to the consumer via a computing device to view and organize said electronic receipt for future returns and financial records.

17. The electronic receipt saver system of claim 16 wherein said computing device comprises one of a wired personal computer, a wireless personal computer, and a personal mobile computing device.
